(19) United States
(12) Patent Application Publication
(10) Pub. No.: US 2026/0194554 A1
(43) Pub. Date: Jul. 9, 2026

(54) Accelerometer

(71) Applicant: SAFRAN ELECTRONICS & DEFENSE, PARIS (FR)

(72) Inventors: Christophe MORELLE, MOISSY-CRAMAYEL (FR); Jean-Sébastien MACE, MOISSY-CRAMAYEL (FR); Philippe ONFROY, MOISSY-CRAMAYEL (FR)

(21) Appl. No.: 19/132,259

(22) PCT Filed: Nov. 15, 2023
(86) PCT No.: PCT/EP2023/081976

§ 371 Date: May 22, 2025

(30) Foreign Application Priority Data
Nov. 23, 2022 (FR) FR2212179

(51) Int. Cl. G01P 15/097; G01L 1/10; G01L 1/14; G01P 1/00; G01P 15/08

(52) U.S. Cl. CPC G01P 15/097; G01L 1/106; G01L 1/14; G01P 1/006; G01P 2015/0814

(57) ABSTRACT

The invention relates to an accelerometer (0) comprising:
a support (Sp);
a mass (M1);
a system (G1) for guiding the mass (M1) along an axis (X-X);
a deformable part (P1); and
a first lever (L1) which pivots about a first pivot point (X1) and is connected to the mass (M1) and to the deformable part (P1) such that the movement of the mass (M1) causes the first lever (L1) to pivot.

The accelerometer (0) comprises a second lever (L2) which pivots about a second pivot point (X2), the second lever being connected to the support and to the deformable part, the first pivot point and the second pivot point being connected via a bar (11) such that, when the mass moves, the levers pivot and deform the deformable part.

### PRIOR ART OF THE INVENTION

The present invention relates to the field of accelerometers.

Patent document US2020025790A1 discloses an accelerometer comprising:
a support;
a mass that is movable relative to the support;
a translational guidance system for the mass relative to the support along a mobility axis of the mass relative to the support;
an elastically-deformable part between the first and second portions of the deformable part; and
a first lever pivoting about a first pivot point, the first lever being mechanically connected, on the one hand, to the mass and, on the other hand, to the first portion of the deformable part such that the movement of the mass relative to the support following along the mobility axis causes the first lever to pivot about the first pivot point that belongs to the support.

It has been observed that the accuracy of the acceleration measurement of this accelerometer is affected by variations in the ambient temperature of the place of use of the accelerometer.

This variation in measurement accuracy as a function of the ambient temperature is problematic because it requires, as the case may be:
selecting accelerometers as a function of the temperature range in which the accelerometer is to be used; and/or providing means for limiting the temperature variations around the accelerometer.

### Aim of the Invention

The invention aims, in particular, to provide an accelerometer having, at least under certain conditions, a relatively constant measurement accuracy over an entire temperature variation range of the place of use of the accelerometer.

### SUMMARY OF THE INVENTION

To this end, an accelerometer is provided, according to the invention, comprising:
a support;
a mass that is movable relative to the support;
a translational guidance system for the mass relative to the support along a mobility axis of the mass relative to the support;
an elastically-deformable part between the first and second portions of the deformable part; and
a first lever pivoting about a first pivot point, the first lever being mechanically connected, on the one hand, to the mass and, on the other hand, to the first portion of the deformable part such that the movement of the mass relative to the support following along the mobility axis causes the first lever to pivot about the first pivot point.

The accelerometer according to the invention is essentially characterised in that it comprises a second lever pivoting about a second pivot point, the second lever being mechanically connected, on the one hand, to the support and, on the other hand, to the second portion of the deformable part, the first pivot point and the second pivot point being connected to one another via a bar such that during said movement of the mass relative to the support, said first and second levers pivot relative to the bar and generate a movement of the first portion of the deformable part relative to the second portion of the deformable part.

With the accelerometer according to the invention, when the mass is subjected to an acceleration along said mobility axis, it moves relative to the support and the movement of the mass relative to the support causes each of the first and second levers to pivot opposite the bar (each bar is a separate part of the support).

The first lever pivots relative to the bar about a first pivot point that forms a first pivot connection between the first lever and the bar.

Similarly, the second lever pivots relative to the bar about a second pivot point that forms a second pivot connection between the second lever and the bar.

The bar is separate from the support and it may move relative to the support as a function of the forces it receives via the first and second pivot points, this movement being, for example, in a direction parallel to the mobility axis of the mass.

The movement of the mass relative to the support makes it possible to generate inertial forces on the levers (due to the inertia of the mass relative to the support) which are re-transmitted to the deformable part via the levers.

These levers make it possible to amplify forces such that the forces respectively applied by the levers to the deformable part are greater than the forces respectively applied to the levers by the mass or by the support.

Thus, the bar and the levers form an inertial force amplifying structure.

Amplifying inertial forces makes it possible to minimise the size of the mass (also called seismic mass or inertial mass).

However, as explained below, the invention makes it possible, by virtue of the pivot points which are formed on the bar, at a distance from the support, to eliminate any risks of amplifying any parasitic forces, i.e., any non-inertial forces such as thermomechanical forces.

The pivoting of the first and second levers induces a movement of the first portion of the deformable part relative to the second portion of the deformable part.

The deformation of the deformable part is consequently a function of the acceleration undergone by the mass along the mobility axis.

It is possible to estimate/measure a current acceleration value undergone by the mass along the mobility axis by observing/measuring physical characteristics of the deformable part which vary as a function of the deformation of the deformable part.

In the accelerometer according to the invention, the first and second levers pivot relative to the same bar, distinct from the support, that connects together the pivot points of these first and second levers.

Consequently, the accelerometer bar is mechanically decoupled relative to the mass and the support, the first lever forming an interface between the mass and the bar and the second lever forming an interface between the support and the bar, the bar being able to move relative to the support. By minimising the stiffness of the coupling of the mass towards the bar or of the support towards the bar, the invention makes it possible to increase the mechanical decoupling of the amplifying structure (the amplifying structure is formed by the levers which pivot relative to the bar about the pivot points) relative to the support and correlatively to minimise the amplification of the thermomechanical forces related to differential expansions between the mass and the support (under a thermal gradient).

Thus, the accuracy (quality) of the measurement of the accelerometer is less affected by the thermal variations applied to the support or to the moving mass.

This particular arrangement of the accelerometer according to the invention may, in certain cases, be useful to eliminate causes of failure and thus improve the lifespan of the accelerometer.

The accelerometer according to the invention thus has less of an impact on the surroundings.

Other features and advantages of the invention will become apparent on reading the following description of particular and non-limiting embodiments of the invention.

### BRIEF DESCRIPTION OF THE DRAWINGS

Reference will be made to the accompanying drawings, in which:

FIG. 1 is a diagrammatic view of a first embodiment of the accelerometer 0 according to the invention, the accelerometer, in this case, comprising a single seismic mass M1 movable relative to the support and functionally connected to/associated with a single deformable part P1, in this case, a resonator that, in this case, is a tuning fork, the measurement of characteristics representative of deformations of the deformable part P1 making it possible to estimate a value of acceleration undergone by the mass M1 along a mobility axis X-X;

FIG. 2 is a diagrammatic view of a second embodiment of the accelerometer 0 according to the invention, the accelerometer, in this case, comprising two seismic masses M1, M2 movable relative to the support Sp along the mobility axis X-X, two deformable parts P1, P2 (which, in this case, are of the resonator type, more particularly, of the tuning fork type) each functionally connected to one of the seismic masses M1, M2 which corresponds to it, this embodiment makes it possible to determine a current acceleration along the mobility axis X-X via two distinct measurements of characteristics of the deformable parts P1, P2 which vary as a function of the acceleration undergone by the masses M1, M2 (as in FIG. 1, a characteristic measured for a given deformable part P1, P2 is, for example, the vibration frequency of the given deformable part maintained/induced by a determined vibratory excitation applied to this given deformable part);

FIG. 3 is a diagrammatic view of a third embodiment of the accelerometer 0 according to the invention, the accelerometer, in this case, comprising a single seismic mass M1 functionally connected to two deformable parts P1, P2 via four pairs of levers L1, L2, L3, L4, the movement of the mass M1 in a first given direction S10 along the mobility axis X-X of the mass M1 relative to the support Sp causing the first deformable part P1 to extend and the second deformable part P2 to compress, conversely the movement of the mass M1 in a second direction opposite to said first direction S10 causing the first deformable part P1 to compress and the second deformable part P2 to extend;

FIG. 4 is a schematic view of half of an accelerometer according to the invention based on a fourth embodiment (in this case, the accelerometer is symmetrical relative to a plane Y-Y perpendicular to the mobility axis X-X), each half of the accelerometer comprises its own seismic mass M1 and its own deformable part P1 that is, on one hand, functionally connected to the mass M1 via a pair of first levers L1 and, on the other hand, functionally connected to the support Sp via a pair of second levers L2, the distance between the mobility axis X-X and the pivot point X1 about which each first lever L1 pivots is, in this case, less than the distance between the mobility axis X-X and the pivot point X2 about which each second lever L2 pivots, this method makes it possible to increase the amplification gain by the levers and, incidentally, to improve the resistance of the accelerometer when subjected to any impacts which may be transverse relative to the mobility axis X-X;

FIG. 5 is a schematic view of a portion of an accelerometer 0 according to the invention associated with a detailed view of a deformable part P1 and a pair of excitation electrodes E1 and detection electrodes E2, these electrodes E1, E2 being associated to measure a current vibratory characteristic of the deformable part P1 that is variable as a function of the forces applied to the deformable part P1, i.e., as a function of the acceleration undergone by the seismic mass M1;

FIG. 6 is a diagrammatic view of a deformable part P1 of an accelerometer 0 according to the invention associated with a central excitation electrode E1 (that extends between the parallel branches of the deformable part P1) and with a pair of lateral detection electrodes E2 (which extend on either side of a pair of branches of the deformable part P1), these electrodes E1, E2 being associated to measure a current vibratory characteristic of the deformable part P1 that is variable as a function of the forces applied to the deformable part P1, i.e., as a function of the acceleration undergone by the seismic mass M1);

FIG. 7 is a diagrammatic view of a deformable part P1 of an accelerometer according to the invention associated with a single central excitation electrode E1 (that extends between the parallel branches of the deformable part P1) and with a pair of lateral detection electrodes E2 (arranged on either side of the branches of the deformable part P1), the teeth carried by the branches of the deformable part and by each of the electrodes E1, E2 are, in this case, interposed (interdigitated) so as to obtain, for each electrode E1, E2, a total surface of facing teeth that varies as a function of lateral movements of the deformable part P1 relative to the mobility axis X-X (this embodiment is advantageous by increasing the detection surface and increasing the signal/noise ratio the accelerometer, moreover, since the total surface of facing teeth varies in proportion to the transverse movements of the deformable part while maintaining an air gap value constant between the facing teeth, this embodiment tends to minimise measurement disturbances caused by electrostatic stiffness);

FIG. 8 is a diagrammatic view of a deformable part P1 of an accelerometer according to the invention associated with a single lateral excitation electrode E1 and a single lateral detection electrode E2, these electrodes E1, E2 being arranged on either side of the pair of parallel branches of the deformable part P1, the deformable part P1 and the electrodes E1, E2 being provided with comb teeth transverse relative to the mobility axis X-X to measure a current vibratory characteristic of the deformable part P1 that is variable as a function of the forces applied to the deformable part P1, i.e., as a function of the acceleration undergone by the seismic mass M1 (or to measure the deformation of part P1) while limiting the disturbances caused by electrostatic stiffnesses between the deformable part P1 and one and/or the other of the electrodes;

FIG. 9 is a diagrammatic view of a deformable part P1 of an accelerometer according to the invention, this deformable part being associated with a single central excitation electrode E1 and a single central detection electrode E2, these electrodes E1, E2 extend between the parallel branches of the deformable part P1 allowing a reduction in the bulk at the periphery of the deformable part P1;

FIG. 10 is a diagrammatic view of a deformable part P1 of an accelerometer according to the invention, this deformable part P1 being associated with a single central excitation electrode E1 and a single central detection electrode E2, these electrodes E1, E2 extend between the parallel branches of the deformable part P1, these branches and these electrodes carrying interposed/interdigitated comb teeth for measuring a current vibratory characteristic of the deformable part P1 that is variable as a function of the forces applied to the deformable part P1, i.e., as a function of the acceleration undergone by the seismic mass M1 (or for measuring lateral deformations of the deformable part P1) while limiting the effects of electrostatic stiffness while limiting the bulk at the periphery of the deformable part P1.

### DETAILED DESCRIPTION OF THE INVENTION

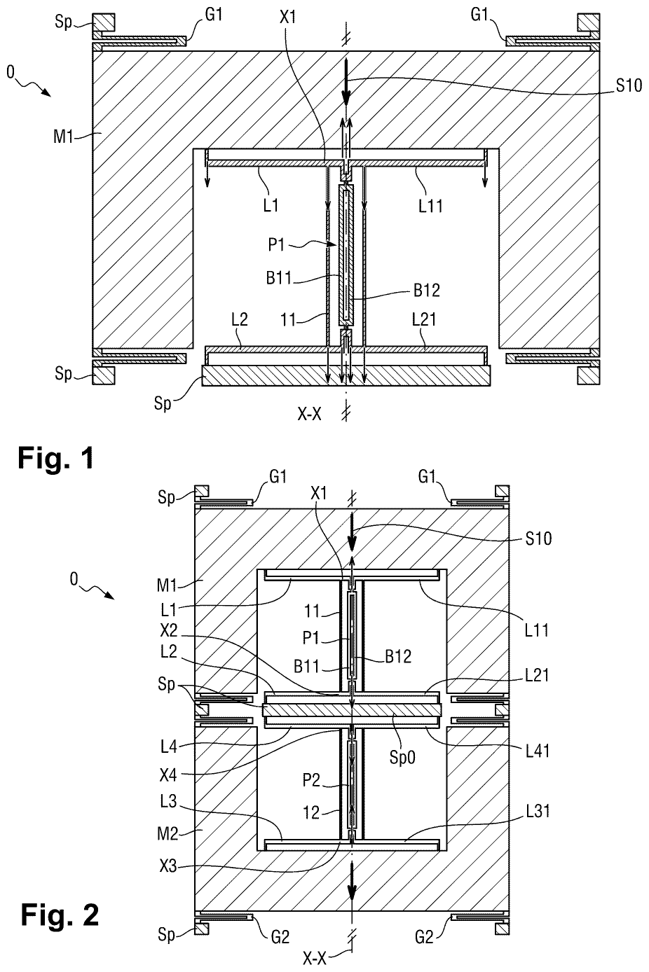

In all of the embodiments shown in FIGS. 1, 2, 3 and 4 of the accelerometer 0 according to the invention, the accelerometer comprises:
a support Sp;
at least one first mobile mass M1 relative to the support Sp;
a translational guidance system G1 for the first mass M1 relative to the support Sp along a mobility axis X-X of the first mass M1 relative to the support Sp;
at least one first elastically-deformable part P1 between the first and second portions of the deformable part P1; and
a first lever L1 pivoting about a first pivot point X1, the first lever L1 being mechanically connected, on the one hand, to the first mass M1 and, on the other hand, to the first portion of the deformable part P1 such that the movement of the mass M1 relative to the support Sp following along the mobility axis X-X causes a pivoting of the causes the first lever L1 to pivot about the first pivot point X1.

The accelerometer 0 also comprises a second lever L2 that pivots about a second pivot point X2.

The second lever L2 is mechanically connected, on the one hand, to the support Sp and, on the other hand, to the second portion of the deformable part P1.

Each given lever L2, L21, L4, L41 of the accelerometer is mechanically connected relative to the support Sp by pressing at a point of contact against the support Sp that is specific to the given lever such that each given lever may pivot relative to the support Sp about the point of contact between the given lever and the support.

The first pivot point X1 and the second pivot point X2 are connected to one another via a first bar 11 such that, during said movement of the first mass M1 relative to the support Sp, said first and second levers L1, L2 pivot relative to the first bar 11 and generate a movement of the first portion of the first deformable part P1 relative to the second portion of the first deformable part P1.

In other words, the movement of a given mass relative to the support Sp generates stresses on the levers, the levers transmitting these stresses to the ends of the deformable part stressed with these levers, the deformable part thus being stressed in traction or in compression as a function of the direction of movement of the given mass relative to the support.

Each given lever thus applies stresses on the deformable part associated with this given lever, these stresses being amplified relative to the stresses exerted on the given lever by the mass associated with it.

The first pivot point X1 is secured to a first end of the first bar 11 and the second pivot point X2 is secured to a second end of the first bar 11.

Each bar is rigid relative to the first deformable part P1 at least along the mobility axis X-X such that during the movement of the mass relative to the support, the deformable part deforms much more than the rigid bar.

In operation, when the first mass M1 is subjected to an acceleration along said mobility axis X-X, this mass M1 moves relative to the support Sp causing a simultaneous pivoting of the first and second levers L1, L2 relative to the first bar 11 that is rigid relative to the deformable part P1.

The pivoting of the first and second levers L1, L2 induces a movement of the first portion of the first deformable part P1 relative to the second portion of the deformable part.

The first deformable part P1 is thus deformed as a function of the current acceleration applied to the first mass M1 along the mobility axis X-X relative to the support Sp.

The first and second levers L1, L2 make it possible to amplify the stresses exerted on the deformable part and to transform the movement of the first mass M1 relative to the support Sp.

Because the first bar 11 relative to which the first and second levers L1, L2 pivot is distinct from the first mass M1 and the support Sp, the invention allows mechanical decoupling between the support and the deformable part(s), making it possible to minimise the amplification of the thermomechanical forces related to differential expansions between the mass and the support (under a thermal gradient).

The accuracy of the accelerometer is thus less affected by temperature variations over a given range of the operating temperatures of the accelerometer.

With the accelerometer 0 according to the invention, the impact of the temperature variation on the quality of the acceleration measurement is particularly reduced compared with prior art accelerometers, such as that of document US2020025790A1.

The accelerometer of the invention is thus more robust against any thermal variations.

The acceleration measurement accuracy is thus relatively stable over the entire lifespan of the accelerometer.

The current acceleration value undergone by the first mass M1 along the mobility axis X-X is estimated/measured as a function of a physical characteristic measurement of the first deformable part P1 that varies as a function of its deformation.

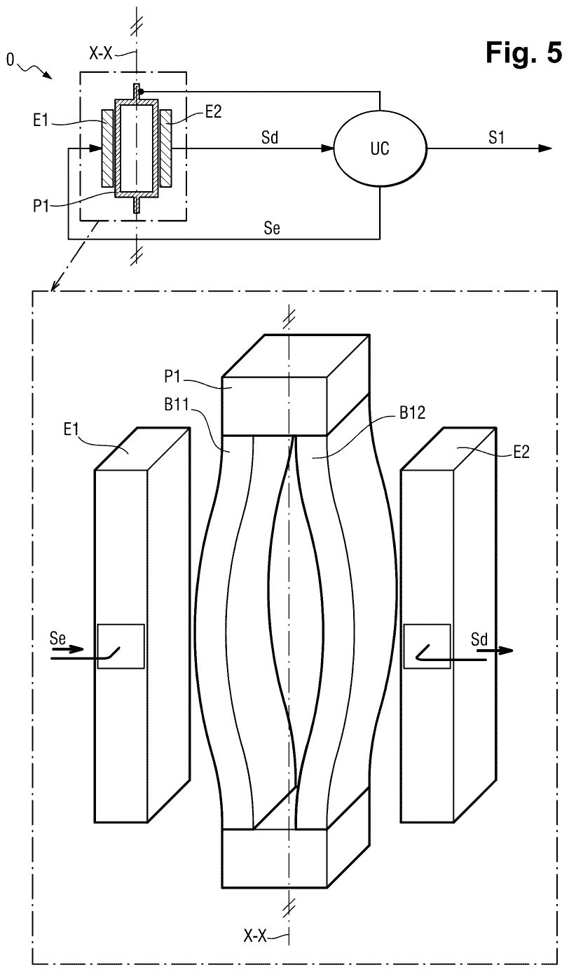

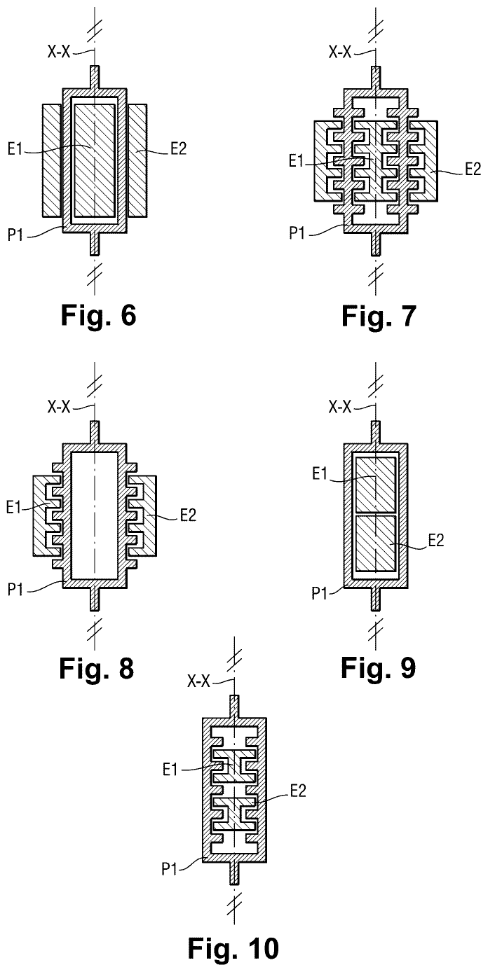

As can be seen below, in particular, with reference to FIGS. 5 to 10, each given deformable part P1, P2 of the accelerometer 0 is elastically deformable at least along the mobility axis X-X.

Preferably, each given deformable part P1, P2 is a resonator-type resonant part whose vibratory characteristics may be measured by using electrodes, these vibratory characteristics being variable as a function of the deformation of the given deformable part P1, P2 and consequently as a function of the current acceleration along the mobility axis X-X. Preferably, a tuning fork is used as a resonator.

Preferably, each given resonator-type deformable part P1, P2 (or, more particularly, tuning fork-type) comprises first and second branches parallel to one another, a first connecting portion connecting first terminal ends of the first and second branches to one another and optionally a second connecting portion connecting second terminal ends of the first and second branches to one another so as to improve the vibratory coupling between these branches. This is referred to, in this case, as branches of a dual embedded resonator/tuning fork.

Thus, vibrating one of the first or second branches causes the other of these branches to vibrate.

The vibratory behaviour of the tuning fork branches varies as a function of the forces applied to the deformable part P1, P2, these forces passing via the first and second branches.

Consequently, the vibratory behaviour of the tuning fork varies as a function of the forces transmitted via the branches, these forces themselves being a function of the current acceleration value undergone by the corresponding mass M1, M2 along the mobility axis X-X.

In each of the embodiments of the accelerometer 0 shown in FIGS. 1, 2, 3 and 4, the support Sp is an interface that makes it possible to mechanically connect the accelerometer 0 to an element of the surroundings external to the accelerometer 0.

For example, the support Sp may define a plane from which projections of the support Sp extend, the mass(es) M1, M2 being mounted facing this plane to be able to translate along this plane, possibly by sliding against this plane of the support Sp.

The projections of the support Sp which extend from the plane of the support form fixed anchors for positioning the constituent elements of the guidance system(s) G1, G2 which make it possible to translationally guide the mass(es) M1, M2 relative to the support and along the mobility axis X-X (the mobility axis X-X, in this case, is parallel to the plane of the support Sp).

The support Sp may, depending on the case, form a bottom of the accelerometer intended to be directly fixed against a structure external to the accelerometer whose acceleration needs to be measured.

This support Sp may also constitute the bottom of a housing of the accelerometer, each mass, lever, deformable part and bar of the accelerometer being located inside the housing.

The first guidance system G1 is adapted to exert elastic return forces of the first mass M1 to a rest position of the first mass M1.

The rest position of the mass M1 is the position in which the mass M1 is located when it is not undergoing any acceleration along the mobility axis X-X, the elastic return forces forcing the mass M1 to translate towards this rest position.

This elastic return force is generated as soon as the mass M1 is moved away from the rest position via translation relative to the support Sp along the mobility axis X-X. In the embodiment of the accelerometer shown in Figure first mass M1, said 2, said movable mass M1 is a f translational guidance system G1 for the first mass M1 is a first guidance system G1, said elastically-deformable part P1 is a first elastically-deformable part P1, said bar is a first bar 11.

This accelerometer 0 of FIG. 2 also comprises:
a second mass M2 that is movable relative to the support Sp;
a second translational guidance system G2 for the second mass M2 relative to the support Sp along said mobility axis X-X of the mass M1 relative to the support Sp;
a second elastically-deformable part P2 between the first and second portions of the deformable part P2;
a third lever L3 pivoting about a third pivot point X3, the third lever L3 being mechanically connected, on the one hand, to the second mass M2 and, on the other hand, to the first portion of the second deformable part P2 such that the movement of the second mass M2 relative to the support Sp following along the mobility axis X-X causes the third lever L3 to pivot about the third pivot point;
a fourth lever L4 pivoting about a fourth pivot point X4.

The fourth lever 14 is mechanically connected, on the one hand, to the support Sp and, on the other hand, to the second portion of the second deformable part P2.

The third pivot point X3 and the fourth pivot point X4 are connected to one another via a second bar 12 (separate from the support) such that, during said movement of the second mass M2 relative to the support Sp, said third and fourth levers L3, L4 pivot relative to the second bar 12 and generate a movement of the first portion of the second deformable part P2 relative to the second portion of the second deformable part P2.

The first, second, third and fourth levers L1, L2, L3, L4 are arranged such that when the first and second masses (M1, M2) move in the same first direction S10 along the mobility axis X-X, it results in an extension of the first deformable part P1 between its first and second portions and a compression of the second deformable part P2 between its first and second portions.

In this embodiment shown in FIG. 2, the third pivot point X3 about which the third lever L3 pivots is secured to a first end of the second bar 12, a bar that is rigid relative to the second deformable part P2, and the fourth pivot point X4 about which the fourth lever L4 pivots is secured to a second end of the second bar 12.

The deformation effects induced on the first and second deformable parts P1, P2 during the movement of the first and second masses M1, M2 relative to the support Sp, following the same direction of movement along the mobility axis X-X (in this case, the direction opposite to said direction S10), are opposite since one of these deformable parts (in this case, part P1) is compressed while the other of these deformable parts is extended (in this case, part P2).

The arrows shown on the levers and bars of the figures show the forces induced during the movement of the mass(es) M1, M2 along the first direction of movement S10 following the mobility axis X-X.

The current acceleration undergone by the first and second masses M1, M2 is, in this case, estimated by performing a differential measurement taking into account the respective deformations of each of the first and second deformable parts P1, P2 (these deformations being opposite).

Naturally, when the masses M1, M2 are moved in the same direction that is opposite to the direction of movement S10 shown in FIG. 2, it results in an extension of the second deformable part P2 between its first and second portions and a compression of the first deformable part P1 between its first and second portions.

The current acceleration is always determined by performing a differential measurement taking into account the respective deformations of the first and second parts P1, P2.

The first translational guidance system G1 is, in this case, formed by a first set of springs interposed between the first mass M1 and the support Sp.

In this case, the second translational guidance system G2 is formed by a second set of springs interposed between the second mass M2 and the support Sp.

The second guidance system G2 is also adapted to exert elastic return forces of the second mass M2 to a rest position of the second mass M2 that is fixed relative to the support Sp.

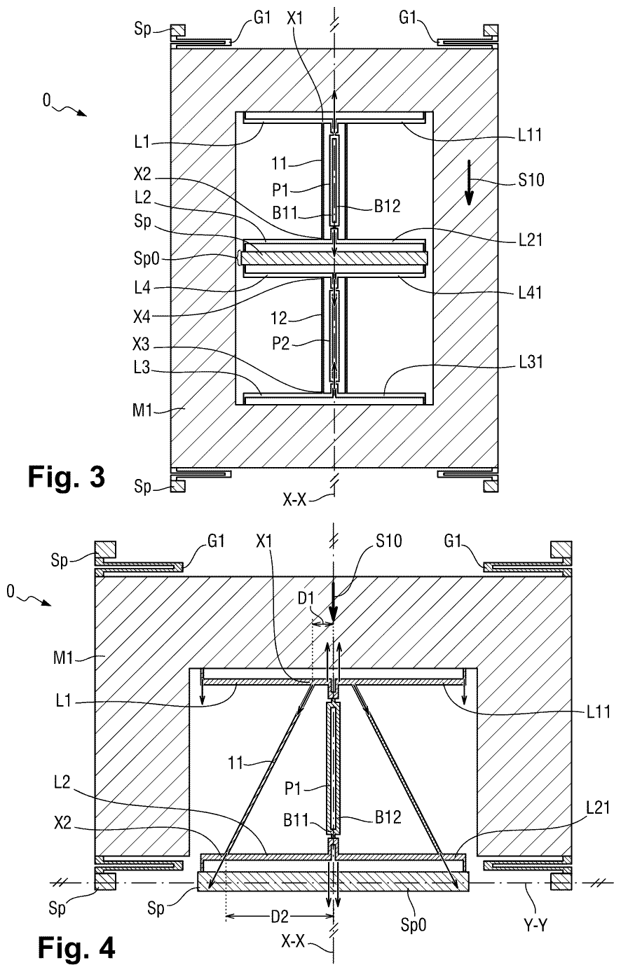

In the embodiment of the accelerometer 0 according FIG. 3, said movable mass M1 is a first mass M1, said translational guidance system G1 of the first mass M1 is a first guidance system G1, said elastically-deformable part P1 is a first elastically-deformable part P1, said bar is a first bar 11.

This accelerometer 0 also comprises:
a second elastically-deformable part P2 between first and second portions of the second deformable part P2;
a third lever L3 pivoting about a third pivot point X3, the third lever L3 being mechanically connected, on the one hand, to the first mass M1 and, on the other hand, to the first portion of the second deformable part P2 such that the movement of the first mass M1 relative to the support Sp along the mobility axis X-X causes a pivoting of the third lever L3 about the third pivot point X3, a fourth lever L4 pivoting about a fourth pivot point X4, the fourth lever L4 being mechanically connected, on the one hand, to the support Sp and, on the other hand, to the second portion of the second deformable part P2;

The third pivot point X3 and the fourth pivot point X4 are connected to one another via a second bar 12 (separate from the support) such that, during said movement of the first mass M1 relative to the support Sp, said third and fourth levers L3, L4 pivot relative to the second bar 12 and generate a movement of the first portion of the second deformable part P2 relative to the second portion of the second deformable part P2.

Furthermore, the first, second, third and fourth levers L1, L2, L3, L4 are, in this case, arranged such that when the first M1 moves in a first direction S10 along the mobility axis X-X, it results in an extension of the first deformable part P1 between its first and second portions and a compression of the second deformable part P2 between its first and second portions.

In this embodiment, the third pivot point X3 about which the third lever L3 pivots is secured to a first end of the second bar 12 and the fourth pivot point X4 about which the fourth lever L4 pivots is secured to a second end of the second bar 12.

This second bar 12 is rigid relative to the second deformable part P2 such that it is the second deformable part P2 that deforms when the masses move relative to the support, the bar 12 retaining its shape.

The deformation effects induced on the first and second deformable parts P1, P2 during the movement of the single mass M1 relative to the support Sp, in a given direction of movement along the mobility axis X-X (in this case, direction S10), are opposite, one of the deformable parts (in this case, part P2) being compressed while the other of the deformable parts (in this case, part P1) is stretched/extended.

Similarly, when the mass M1 moves relative to the support Sp in a direction opposite to the direction S10 along the axis X-X, the deformable part P1 is then compressed while the deformable part P2 is stretched/extended.

As in the embodiment of FIG. 2, the embodiment in FIG. 3 makes it possible to estimate the current acceleration undergone by the first mass M1 (single mass) by performing a differential measurement taking into account the respective deformations of each of the first and second deformable parts P1, P2 (these deformations being opposite).

In each of the embodiments of the accelerometer according to the invention, each rigid bar 11, 12 serving as a pivot for the levers is preferably suspended between levers away from the mass(es) and away from the support, making it possible to minimise the amplification of the thermomechanical forces related to differential expansions between the mass and the support (under a thermal gradient).

Thus, the bar 11 is integrally carried by the first and second levers L1, L2 and it is suspended between the first and second levers L1, L2.

Likewise, the bar 12 is integrally carried by the third and fourth levers L3, L4 and it is suspended between these third and fourth levers L3, L4.

Also, each deformable part P1, P2 is also suspended by levers allowing thermomechanical decoupling of each deformable part P1, P2 relative to the masses and the support.

Thus, the deformable part P1 is integrally carried by the first and second levers L1, L2 and it is suspended between these first and second levers L1, L2.

Similarly, as shown in the embodiments in FIGS. 2 to 4, the deformable part P2 is integrally carried by the third and fourth levers L3, L4 and it is suspended between these third and fourth levers L3, L4.

This embodiment of suspending the deformable parts and the bars allows thermomechanical decoupling, limiting any variations in measurement accuracy induced by differential expansions between the mass M1 and the support generating forces on the deformable parts P1, P2.

The accuracy of the accelerometer 0 according to the invention is thus stabilised and less affected by any thermal variations.

As can be seen in the various FIGS. 1 to 4, each of the levers L1, L2, L3, L4 is used in order to amplify, by leverage, the stress, i.e., the deformation force, applied to each deformable part P1, P2.

For this purpose, the first pivot point X1 is separated from a mechanical connection point between the first mass M1 and the first lever L1 by a distance greater than a distance separating the first pivot point X1 relative to a mechanical connection point between the first portion of the deformable part P1 and the first lever L1.

Similarly, in the embodiments of FIGS. 1 to 3, the second pivot point X2 about which the second lever L2 pivots is separated from a mechanical connection point between the support Sp and the second lever L2 by a distance greater than a distance separating the second pivot point X2 relative to a mechanical connection point between the second portion of the deformable part P2 and the second lever L2.

For a constant given mass M1, M2, utilising force amplifying levers L1, L2, L3, L4 is useful for increasing the sensitivity of the accelerometer.

Correspondingly, amplifying the forces by using the levers may be used to reduce the moving mass/masses M1, M2 while maintaining the same sensitivity of the acceleration measurement.

It must be noted that minimising the mass is useful for miniaturising and/or lightening the accelerometer and/or reducing the quantity of material required for its manufacture.

In the embodiments of FIGS. 2 to 3, this same force amplification principle is preferably used for each given lever of the accelerometer (see, in particular, levers L1, L2, L3, L4), such that:
the distance between the pivot point of the given lever (i.e., the junction point of this given lever with the corresponding bar relative to which this given lever pivots) and the junction point of this given lever with the corresponding deformable part; is always less than
the distance between this pivot point of the given lever and the junction point of this given pivot with, as the case may be, the corresponding mass M1, M2 or the support Sp.

As can be seen in the various embodiments shown in FIGS. 1 to 4, the first and second levers L1, L2 are orientated such that the movement of the first mass M1 relative to the support Sp along the mobility axis X-X and in a first direction of movement of the mass M1 causes an increase in spacing between said first and second portions of the first deformable part P1.

The relative movement between the first and second portions of a deformable part directly influences the vibratory characteristics of this deformable part such as the frequency of a given natural resonance mode of the deformable part.

In each of the described embodiments of the accelerometer according to the invention, the accelerometer is symmetrical relative to a main plane of symmetry comprising the mobility axis X-X.

More particularly, the first lever L1 belongs to a pair of first levers L1, L11 which are arranged symmetrically relative to the mobility axis X-X.

The second lever L2 belongs to a pair of second levers L2, L21 which are arranged symmetrically relative to the mobility axis X-X, the first and second portions of the deformable part P1 are arranged on the mobility axis X-X.

Each lever of the pair of first levers L1, L11 is pivotingly mounted relative to the first bar 11 at a pivot point specific to each lever (X1 for the lever L1).

The pivot points about which the first levers L1, L11 pivot are arranged on either side and equidistant from the mobility axis X-X.

Similarly, each second lever of the pair of second levers L2, L21 is pivotingly mounted relative to the first bar 11 at a pivot point specific to each lever L2, L21.

The pivot points about which the second levers L2, L21 pivot are arranged on either side and equidistant from the mobility axis X-X.

In the embodiments in which the invention comprises third and fourth levers L3, L4, i.e., the embodiments of FIGS. 2 and 3:
the third lever L3 belongs to a pair of third levers L3, L31 which are arranged symmetrically relative to the mobility axis X-X and the fourth; and
the fourth lever L4 belongs to a pair of fourth levers L4, L41 which are arranged symmetrically relative to the mobility axis X-X, the first and second portions of the second deformable part P2 are arranged on the mobility axis X-X.

Each lever of the pair of third levers L3, L31 is pivotingly mounted relative to the second bar 12 at a pivot point specific to each lever (X3 for the lever L3).

The pivot points about which the third levers L3, L31 pivot are arranged on either side and equidistant from the mobility axis X-X.

Similarly, each of the levers of the pair of fourth levers L4, L41 is pivotingly mounted relative to the second bar 12 at a pivot point X4 specific to each lever.

The pivot points about which the fourth levers L4, L41 pivot are arranged on either side and equidistant from the mobility axis X-X.

It must be noted that the distance of the pivot points of a pair of levers relative to the mobility axis X-X may be different from one pair of levers to another pair of levers.

For example, in the embodiment shown in FIG. 4:
the pivot points about which the first levers L1, L11 pivot relative to the bar 11 are respectively separated from the mobility axis X-X by a first separation distance D1; whereas
the pivot points about which the second levers L2, L21 pivot relative to the bar 11 are respectively separated from the mobility axis X-X by a second separation distance D2, the second separation distance D2 being several times greater than the first separation distance D1.

This embodiment is useful for increasing the amplification gain by the levers and, incidentally, for improving the positioning stability of the first and second levers L1, L11, L2, L21 on either side of the mobility axis X-X.

As a result, the accelerometer 0 is more resistant to any transverse impacts relative to the mobility axis X-X.

FIG. 4 shows only one half of the accelerometer 0, this accelerometer having a symmetry relative to the plane Y-Y that is perpendicular to the mobility axis X-X.

In order to increase the amplification gain by the levers and improve the stability of the accelerometer in the face of any lateral impacts, the distance of the pivot points of the levers of the third pair of levers relative to the mobility axis X-X is preferably much less than the distance between the pivot points of the levers of the fourth pair of levers relative to the mobility axis X-X.

To return to the particular embodiment shown in FIG. 3, the first mass M1 is hollowed out at its centre, the levers L1, L2, L3, L4 and the deformable parts P1, P2 are placed in the hollowed out section of this first mass M1.

A central portion Sp0 of the support Sp extends into the hollowed out section of the first mass P1, the second and fourth levers L2, L4 are mechanically connected to the support Sp via this same central portion Sp0 of the support.

More precisely, the central portion Sp0 of the support Sp extends between the second and fourth levers L2, L4, the mechanical connection between the second lever L2 and the support Sp being made on one side of the central portion Sp0 while the mechanical connection between the fourth lever L4 and the support Sp is made on the other side of the central portion Sp0.

With reference to FIGS. 5 to 10, here follows a detailed description of different measurement means of the accelerometer according to the invention used to measure characteristics of the deformable parts P1 and/or P2 which vary as a function of the acceleration, these characteristics thus being used to deduce a current acceleration value applied to the accelerometer 0 along the axis X-X.

To this end, the accelerometer comprises an electronic device UC arranged to measure at least one physical characteristic specific to each of the deformable parts P1, P2 and variable as a function of the deformation of the deformable part P1, P2 in question.

Thus, in the particular embodiments in which the accelerometer comprises two deformable parts P1, P2 (FIGS. 2 and 3), the electronic device UC measures a first physical characteristic of the first deformable part P1 and a second physical characteristic of the second deformable part P2, each of these physical characteristics varying as a function of the respective deformations of each deformable part P1, P2.

The electronic device UC determines a current acceleration value as a function of the measurement of the first physical characteristic and, in embodiments comprising two deformable parts, as a function of the measurement of said second physical characteristic specific to part P2. The electronic device UC delivers a measurement signal S1 representative of said current acceleration value undergone by the mass, this signal S1 being determined as a function of the physical characteristics measured on the deformable part(s) P1, P2.

In the present example, each deformable part P1, P2 is a resonator comprising first and second branches arranged such that the vibration of one of the first or second branches causes the other of the first or second branches to vibrate.

The fact of having a resonator with two branches makes it possible to have a vibratory relationship between both of the branches that is useful for evaluating a current acceleration value as a function of vibrations measured on at least one of the branches.

The first physical characteristic of the first deformable part P1 that is measured by the electronic device UC is preferably a current vibratory characteristic of at least one of said first or second branches.

Likewise, the measured second physical characteristic of the second deformable part P2 is preferably a current vibratory characteristic of at least one of said first or second branches.

Preferably, as shown in FIG. 5, the electronic device UC:
generates an excitation signal Se to maintain/induce a vibration on the deformable part; and
determines the current acceleration value as a function of the excitation signal Se and of a detection signal Sd representative of the measurement of the first physical characteristic and/or of the measurement of the second physical characteristic performed by the electronic device UC.

As can be understood from FIGS. 5 to 10, the accelerometer comprises, for each given deformable part P1, P2:
a first electrode E1 placed opposite the first branch of the given deformable part; and
a second electrode E2 placed opposite the second branch of the given deformable part P1, P2.

The electronic device UC is electrically connected to each given deformable part P1, P2 and to each of said first and second electrodes E1, E2 associated with the given deformable part P1, P2.

The electrical connection between the electronic device and each deformable part P1, P2 may be made via the support Sp and the levers which are electrically conductive (ideally all the masses M1, M2, supports Sp, levers L1, L2, L3, L4, bars 11, 12 and deformable parts 11, 12 are electrically conductive and are at the same DC bias voltage VO relative to the excitation electrodes E1 to which an AC component is added).

The electrical connection of the electronic device UC with the electrodes E1, E2 is arranged to:
on the one hand, apply said excitation signal Se between one of the first or second electrodes E1, E2 and the deformable part, this excitation signal Se consisting of a variation in electrical potential; and in order to
on the other hand, generate said detection signal Sd as a function of a variation in capacitive load measured between the other of said first or second electrodes E1, E2 and the deformable part supplied.

The detection signal Sd is actually the capacitive load variation (or the modulated current that depends on the capacitive load variation) under the effect of the capacitance variation induced by the deformation of the branch of the deformable part P1 that is a tuning fork type resonator. Preferably, this capacitive load variation measurement is made with a fixed potential difference between one of the first or second electrodes E1, E2 and the given deformable part.

In the present example, the excitation signal Se is a difference in electrical potential applied between the deformable part P1 (that is made of an electrically conductive material) and the corresponding electrode E1, the deformable part P1 having a DC bias, the potential of the electrode E1 consisting of:
a continuous component (Vₘₒₜ) that may be zero; and
an alternating component that is at a frequency preferably equal to that of an eigen mode of the resonator, i.e., the useful mode.

In this sense, the deformable part P1 is maintained at a DC potential, the first electrode E1 having a first electrode potential and the second electrode E2 having a second electrode potential.

The potential difference between one of the resonator-type branches of the deformable part P1 and the electrode E1 opposite this given branch makes it possible to generate an electrostatic force that vibrates the branches of the resonator at the natural frequency of the useful mode.

The branches of the deformable part vibrate by mechanical/vibratory coupling between these branches.

Each second detection electrode E2 placed opposite a second branch of a given deformable part P1, P2 is used to generate a detection signal Sd representative of vibratory characteristics of the given deformable part P1, P2. As the case may be, the generated detection signal Sd isa measurement signal or a signal generated as a function of the measurement signal.

Each given detection signal Sd consists of an alternating current component i_{det} obtained by capacitive detection between the corresponding second detection electrode E2 and the corresponding deformable part P1, P2.

In practice, the DC electrical potential component Vdet is zero.

The detection electrode E2 may be directly connected to the input of a load amplifier of the electronic device UC and a DC electrical potential component Vdet may be applied to the corresponding second sensing electrode E2. This DC electrical potential component Vdet may be zero.

In summary, in these embodiments, the current acceleration value is determined by the electronic device UC based on:
the detection signal Sd (that varies as a function of the current vibratory characteristics of each given deformable part 11, 12); and
the excitation signal Se (that is known and that generates vibrations directly on one of the branches of the resonator and indirectly on the other branch of the resonator (via vibratory coupling).

The accelerometer according to the invention is preferably a microelectromechanical system (MEMS) such as the support Sp, the moving mass(es) M1, M2, the levers L1, L2, L3, L4, the bar(s) 11, 12 and, optionally, the elastically deformable part(s) P1, P2 are obtained:
by additive manufacturing; and/or
by removing material on the basis of a block of material (e.g., by etching).

Preferably, the elastically deformable part(s) P1, P2 and, optionally, the electrode(s) E1, E2 are obtained from one or more blocks of semiconductor material(s).

Preferably, the accelerometer 0 is made from a stack of 3 layers (2 silicon layers separated by a silicon dioxide layer that forms an intermediate layer of the stack). This stacking is called “SOI-Silicon On Insulator”. This allows for electrical isolation between the resonator branches and the electrodes.

More specifically, fixed portions of the accelerometer which comprise the electrodes and portions of the support are formed in portions of the upper silicon layer which are respectively connected to the lower silicon layer of the stack via portions of the silicon dioxide layer (intermediate layer of the stack).

The lower layer of silicon forms a substrate that belongs to the support.

The silicon dioxide layer of the stack is etched facing all of the moving portions relative to the support, i.e., facing each mass, lever, bar, deformable part P1, P2, and translational guidance system G1, G2, these moving portions thus being made only in the upper silicon layer of the stack.

The etching of the silicon dioxide layer is performed so as to guarantee a mobility of the mobile portions of the accelerometer relative to the lower silicon layer that is fixed and that supports all of the fixed portions of the accelerometer.

Naturally, the invention is not limited to the embodiment described, but covers any variant included within the scope of the invention as defined by the claims.

In particular, the excitation signal Se and/or detection signal Sd may be delivered by transducers, such as one or more piezoelectric transducers.

In this case, each transducer would be individually coupled with an associated deformable part (P1, P2) in order to vibrate it.

Likewise, the levers used to amplify the forces may have flexural elasticities to form decoupling springs.

In embodiments in which the accelerometer comprises two moving masses, these masses may be connected together via coupling springs between the masses.

The measured physical characteristic of a given deformable part is measured using any of the measurement means shown in FIGS. 5 to 10.

In terms of the embodiments in which the accelerometer comprises two deformable parts, it is preferable to use first measurement means for the first deformable part according to any one of FIGS. 5 to 10 and second measurement means for the second deformable part in accordance with any one of FIGS. 5 to 10, the first and second measurement means being preferentially identical to one another.

1. An accelerometer-comprising:
a support;
a mass that is movable relative to the sup-port;
a translational guidance system of the mass relative to the support along a mobility axis of the mass relative to the support;
an elastically-deformable part between the first and second portions of the deformable part; and
a first lever pivoting about a first pivot point, the first lever being mechanically connected, on the one hand, to the mass and, on the other hand, to the first portion of the deformable part such that the movement of the mass relative to the support along the mobility axis causes the first lever to pivot about the first pivot point, wherein the accelerometer comprises a second lever pivoting about a second pivot point, the second lever being mechanically connected, on the one hand, to the support and, on the other hand, to the second portion of the deformable part, the first pivot point and the second pivot point being connected to one another via a bar such that during said movement of the mass relative to the sup-port, said first and second levers pivot relative to the bar and generate a movement of the first portion of the deformable part relative to the second portion of the deformable part.

2. The accelerometer according to claim 1, wherein the guidance system is adapted to exert elastic re-turn forces of the mass to a rest position of the mass.

3. The accelerometer according to claim 1, wherein the deformable part is integrally carried by the first and second levers and it is suspended between the first and second levers.

4. The accelerometer according to claim 1, wherein the bar is integrally carried by the first and second levers and it is suspended between the first and second levers.

5. The accelerometer according to claim 1, wherein the first pivot point about which the first lever pivots is separated from a mechanical connection point between the mass and the first lever by a distance greater than a distance separating the first pivot point relative to a mechanical connection point between the first portion of the deformable part and the first lever.

6. The accelerometer according to claim 5, wherein the second pivot point about which the second lever pivots is separated from a mechanical connection point between the support and the second lever by a distance greater than a distance separating the second pivot point relative to a mechanical connection point between the second portion of the deformable part and the second lever.

7. The accelerometer according to claim 1, wherein the first and second levers are orientated such that the movement of the mass relative to the support along the mobility axis and in a first direction of movement of the mass causes an increase in spacing between said first and second portions of the deformable part.

8. The accelerometer according to claim 1, further comprising an electronic device arranged, on the one hand, to measure at least one first physical characteristic of the deformable part-var-ying as a function of the deformation of the deformable part between said first and second portions and, on the other hand, to determine a current acceleration value undergone by the mobile mass along the mobility axis as a function of the measurement of said first physical characteristic of the deformable part.

9. The accelerometer according to claim 8, wherein the deformable part is a resonator, said first physical characteristic of the deformable part measured by the electronic device is a current vibratory characteristic of the resonator, and wherein the electronic de-vice is arranged to generate an excitation signal to induce vibration on the deformable part, the electronic device being arranged so that said determination of the current acceleration value is a function of the excitation signal and of a detection signal representative of the measurement of the first physical characteristic by the electronic device.

10. The accelerometer according to claim 9, wherein the resonator comprises first and second branches arranged such that the vibration of one of the first or second branches causes the vibration of the other of the first or second branches, a first electrode placed opposite the first branch and a second electrode placed opposite the second branch, the electronic device being electrically connected to said deformable part and to each of said first and second electrodes so as to:
on the one hand, apply said excitation signal between one of the first or second electrodes and the deformable part, this excitation signal consisting of a variation in electrical potential; and
on the other hand, generate said detection signal as a function of a variation in capacitive load measured between the other of said first or second electrodes and the deformable part.

11. The accelerometer according to claim 1, wherein said movable mass is a first mass, said translational guidance system of the first mass is a first guidance system, said elastically-deformable part is a first elastically-deformable part, said bar is a first bar, the accelerometer further comprising:
a second mass that is movable relative to the sup-port;
a second translational guidance system of the second mass-relative to the support along said mobility axis of the mass relative to the support;
a second elastically-deformable part between the first and second portions of the deformable part; and
a third lever pivoting about a third pivot point, the third lever being mechanically connected, on the one hand, to the second mass and, on the other hand, to the first portion of the second de-formable part such that the movement of the second mass relative to the support following along the mobility axis causes the third lever to pivot about the third pivot point;
a fourth lever pivoting about a fourth pivot point, the fourth lever being mechanically connected, on the one hand, to the support and, on the other hand, to the second portion of the second de-formable part, the third pivot point and the fourth pivot point being connected to one another via a second bar such that during said movement of the second mass relative to the support said third and fourth levers pivot relative to the second bar and generate a movement of the first portion of the second deformable part relative to the second portion of the second deformable part, the first, second, third and fourth levers being arranged such that when the first and second masses move in the same direction along the mobility axis, it results in a compression of the first deformable part between its first and second portions and an extension of the second deformable part between its first and second portions.

12. The accelerometer according to claim 1, wherein the first lever belongs to a pair of first levers which are arranged symmetrically relative to the mobility axis, the second lever belongs to a pair of second levers which are arranged symmetrically relative to the mobility axis, the first and second portions of the de-formable part being arranged on the mobility axis;
each lever of the pair of first levers is pivotingly mounted relative to the bar at a pivot point of its own, the pivot points about which the first levers pivot being arranged on either side and equidistant from the mobility axis;
each second lever of the pair of second levers is pivotingly mounted relative to the bar at a pivot point of its own, the pivot points about which the second levers pivot being arranged on either side and equidistant from the mobility axis.

13. The accelerometer according to claim 12, wherein:
the pivot points about which the first levers pivot relative to the bar are respectively separated from the mobility axis by a first separation distance; and
the pivot points about which the second levers pivot relative to the bar are respectively separated from the mobility axis by a second separation distance, the second separation distance being several times greater than the first separation distance.

14. The accelerometer according to claim 1, wherein said movable mass is a first mass, said translational guidance system of the first mass is a first guidance system, said elastically-deformable part is a first elastically-deformable part, said bar is a first bar, the accelerometer further comprising:
a second elastically-deformable part between first and second portions of the second deformable part;
a third lever pivoting about a third pivot point, the third lever being mechanically connected, on the one hand, to the first mass and, on the other hand, to the first portion of the second de-formable part such that the movement of the first mass relative to the support along the mobility axis causes a pivoting of the third lever about the third pivot point, a fourth lever pivoting about a fourth pivot point, the fourth lever being mechanically connected, on the one hand, to the support and, on the other hand, to the second portion of the second deformable part;
the third pivot point and the fourth pivot point being connected to one another via a second bar such that during said movement of the first mass relative to the support said third and fourth levers pivot relative to the second bar and generate a movement of the first portion of the second deformable part relative to the second portion of the second deformable part, the first, second, third and fourth levers being arranged such that when the first mass moves in a di-rection along the mobility axis, it results in a compression of the first deformable part between its first and second portions and an extension of the second deformable part between its first and second portions.
